(19) United States
(12) Patent Application Publication
(10) Pub. No.: US 2008/0066035 A1
(43) Pub. Date: Mar. 13, 2008

(54) Method and design system of semiconductor integrated circuit

(75) Inventor: Kazuki Asao, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/896,984

(22) Filed: Sep. 7, 2007

(30) Foreign Application Priority Data
Sep. 11, 2006 (JP) 2006-245136

(51) Int. Cl. G06F 17/50

(52) U.S. Cl. 716/6

(57) ABSTRACT

Disclosed is a design method for optimizing the timings at which a plurality of power supply switches in a power gating circuit in a semiconductor integrated circuit by the steps of (A) providing a motion model of the power gating circuit, (B) setting a constraint on in-rush current, (C) performing a circuit simulation using the motion model, and (D) generating timing data indicating the timings at which the plurality of power supply switches are turned on based on the result of the circuit simulation. The design method enables easy designing of a semiconductor integrated circuit where the plurality of power supply switches are turned on by step so that the constraint on the in-rush current is satisfied.

### BACKGROUND OF THE INVENTION

1. Field of the Invention

The present invention relates to a design technique of a semiconductor integrated circuit. In particular, the present invention relates to a design technique of a semiconductor integrated circuit having therein a power gating circuit.

2. Description of the Related Art

In the field of a semiconductor integrated circuit, to lower the power consumption is an important problem. In particular, in a semiconductor integrated circuit mounted in battery-powered portable equipment, it is important to lower the power consumption on which the battery operating time of the portable equipment depends. The power consumption can be broken down into power consumption in an active mode and power consumption in a standby mode. The power consumption in the standby mode mainly depends on leakage current of a transistor in the semiconductor integrated circuit.

“Power gating” is a known technique for lowering the power consumption in the standby mode. Power gating interrupts power supply to a functional block which is not operated in the standby mode. In order to attain this, a power gating circuit is provided between a functional block subject to the power gating and a power supply. In the standby mode, the power gating circuit interrupts power supply to a functional block subject to the power gating. As a result, leakage current in the functional block is greatly decreased, and the power consumption in the standby mode is lowered.

Generally, a power gating circuit is provided with a power supply switch. When power supply to the functional block is resumed, the power supply switch is turned on. Here, “in-rush current” flows through the power gating circuit. The in-rush current causes power supply noise, which is a cause of a malfunction of a functional block that is not subject to the power gating. In particular, when a peak value of the in-rush current is large, the adverse effect is conspicuous.

One way to lower the peak value of the in-rush current would be to provide in the power gating circuit a plurality of power supply switches connected in parallel, and to turn on the plurality of power supply switches one by one. For example, Suhwan Kim et al., “Understanding and Minimizing Ground Bounce During Mode Transition of Power Gating Structures”, International Symposium on Low Power Electronics and Design (ISLPED) 2003, Proceedings, pp. 22-25 discloses a power gating circuit provided with a plurality of power supply switches and a plurality of delay circuits.

In the document, the plurality of power supply switches are connected to each other in parallel between a functional block and a grand power supply. The plurality of delay circuits are connected in series, and supply an ON signal to the plurality of power supply switches one by one. Delay times of these delay circuits make the plurality of power supply switches turned on one by one. As a result, time periods during which the in-rush current is caused with regard to the respective power supply switches shift to lower the peak value of the in-rush current.

However, in the power gating circuit disclosed in the document, when the delay times of the delay circuits are too short, the time periods during which the in-rush current is generated is caused to overlap. This increases the peak value of the in-rush current, which is a cause of a malfunction of the circuit due to power supply noise.

### SUMMARY OF THE INVENTION

The present invention seeks to solve one or more of the above problems, or to improve upon those problems at least in part.

According to a first aspect of the present invention, a design method of a semiconductor integrated circuit is provided. The semiconductor integrated circuit to be designed has therein a power gating circuit (10) being provided between a functional block (1) and a power supply, and having a plurality of power supply switches (SW1-SWn) connected to in parallel each other. The design method according to the present invention includes the steps of (A) providing a motion model (20) of the power gating circuit (10), (B) setting a constraint on in-rush current, and (C) performing a circuit simulation using the motion model (20). In the circuit simulation, the motion model (20) turns on the plurality of power supply switches (SW1-SWn) step by step such that the set constraint is satisfied. Exemplary constraints on the in-rush current include the maximum value (admissible value) of the in-rush current and the maximum value (admissible value) of variation per unit time of the in-rush current.

The design method according to the present invention further includes the step of (D) generating timing data (121) indicating the timings at which the plurality of power supply switches (SW1-SWn) are turned on respectively, in response to the result of the circuit simulation. The timings at which the plurality of power supply switches (SW1-SWn) are turned on indicated by the timing data (121) are, as described in the above, determined such that a desired constraint on the in-rush current is satisfied. In other words, by turning on the plurality of power supply switches (SW1-SWn) at the timings, the in-rush current constraint is satisfied. Therefore, actual design of the power gating circuit (10) may be performed referring to the generated timing data (121). Thus, the power gating circuit (10) which satisfies the desired in-rush current constraint is automatically obtained.

In this way, according to the design method of the present invention, the circuit simulation using the motion model (20) automatically determines the timings at which the plurality of power supply switches (SW1-SWn) are turned on which satisfy the desired in-rush current constraint. The power gating circuit (10) designed referring to the timings automatically satisfies the desired in-rush current constraint. Therefore, a malfunction of the circuit due to power supply noise is prevented.

In the circuit simulation, the motion model (20) may gradually increase the time interval between two temporally adjacent timings at which the plurality of power supply switches (SW1-SWn) are turned on from a predetermined value. In that case, the motion model (20) fixes the time interval between the two temporally adjacent timings immediately after the desired in-rush current constraint is satisfied. Therefore, the time interval between two temporally adjacent timings is prevented from becoming meaninglessly long. As a result, time until operation of the functional block (1) is resumed is prevented from becoming too long, and thus, the operation speed of a semiconductor integrated circuit having therein the power gating circuit (10) is prevented from being decreased.

According to a second aspect of the present invention, a design system of a semiconductor integrated circuit is provided. The semiconductor integrated circuit to be designed has therein a power gating circuit (10) being provided between a functional block (1) and a power supply, and having a plurality of power supply switches (SW1-SWn) connected to in parallel each other. The design system (100) according to the present invention includes a memory (120) for storing a motion model (20) of the power gating circuit (10), a processing unit (110) for reading the motion model (20) from the memory (120) and for performing a circuit simulation of the motion model (20). In the motion model (20), a constraint on in-rush current is set. In the circuit simulation, the motion model (20) turns on the plurality of power supply switches (SW1-SWn) step by step so that the constraint is satisfied. The processing unit (110) generates timing data (121) indicating the timings at which the plurality of power supply switches (SW1-SWn) are turned on based on the result of the circuit simulation.

According to the present invention, the timings at which the plurality of power supply switches of the power gating circuit in the semiconductor integrated circuit are turned on can be automatically set such that the desired in-rush current constraint is satisfied. Therefore, a malfunction of the circuit due to power supply noise can be prevented.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a schematic circuit diagram of an exemplary semiconductor integrated circuit to be designed according to the present invention;

FIG. 2 is a schematic circuit diagram of another exemplary semiconductor integrated circuit to be designed according to the present invention;

FIG. 3 is a circuit diagram illustrating an exemplary structure of a power gating circuit;

FIG. 4 illustrates functions of a motion model of the power gating circuit according to an embodiment of the present invention;

FIG. 5 is a conceptual diagram illustrating the motion model of the power gating circuit according to the embodiment of the present invention;

FIG. 6 illustrates an exemplary HDL description of a power supply switch module of the motion model according to the present embodiment;

FIG. 7 illustrates an exemplary HDL description of a capacitance module of the motion model according to the present embodiment;

FIG. 8 illustrates an exemplary HDL description of a leakage current module of the motion model according to the present embodiment;

FIG. 9 is a flowchart illustrating operation of the motion model according to the present embodiment in a circuit simulation;

FIG. 10 is a block diagram illustrating a structure of an LSI design system according to the present embodiment; and

FIG. 11 is a flow chart illustrating a design method of the semiconductor integrated circuit according to the present embodiment.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

A design technique of a semiconductor integrated circuit according to an embodiment of the present invention is now described in the following with reference to the attached drawings.
1. Semiconductor Integrated Circuit to be Designed

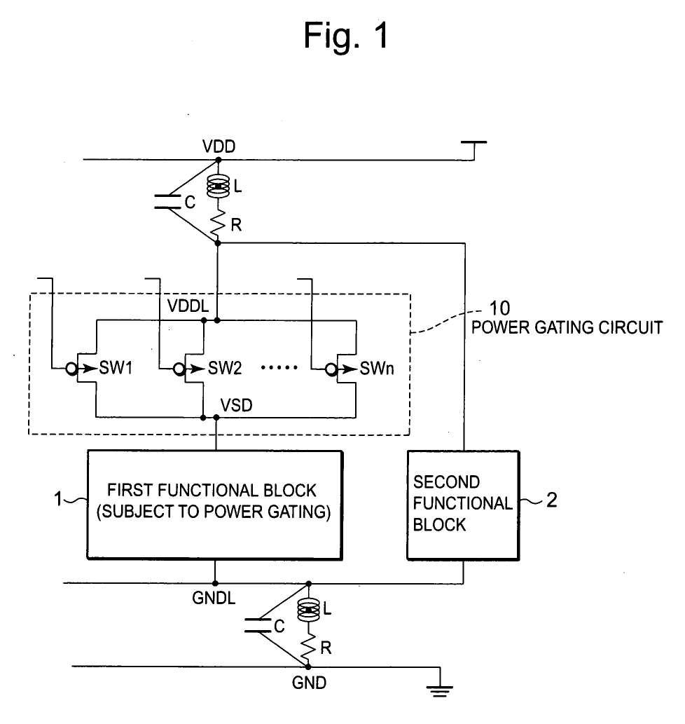

A semiconductor integrated circuit to be designed according to the present invention has therein a power gating circuit for performing power gating. FIG. 1 schematically illustrates an exemplary semiconductor integrated circuit to be designed. The semiconductor integrated circuit illustrated in FIG. 1 includes a first functional block 1, a second functional block 2, and a power gating circuit 10. The first functional block 1 is subject to the power gating, and, in a standby mode, power supply to the first functional block 1 is interrupted. On the other hand, the second functional block 2 is a functional block which is not subject to the power gating. The first functional block 1 and the second functional block 2 are connected to common power supplies (VDD and GND).

The power gating circuit 10 is provided between the first functional block 1 and a power supply. Although, in FIG. 1, the power gating circuit 10 is provided between the first functional block 1 and the power supply VDD, it may be provided between the first functional block 1 and the grand power supply GND. In FIG. 1, input voltage to the power gating circuit 10 is VDDL while output voltage from the power gating circuit 10 is VSD. Input voltage to the first functional block 1 is VSD while output voltage from the first functional block 1 is GNDL.

As illustrated in FIG. 1, the power gating circuit 10 has a plurality of power supply switches SW1-SWn. The total number of the power supply switches is n (n is an integer equal to or larger than 2). These power supply switches SW1-SWn are provided in parallel between the power supply and the first functional block 1. Each power supply switch SW is formed of a p-channel MOS transistor.

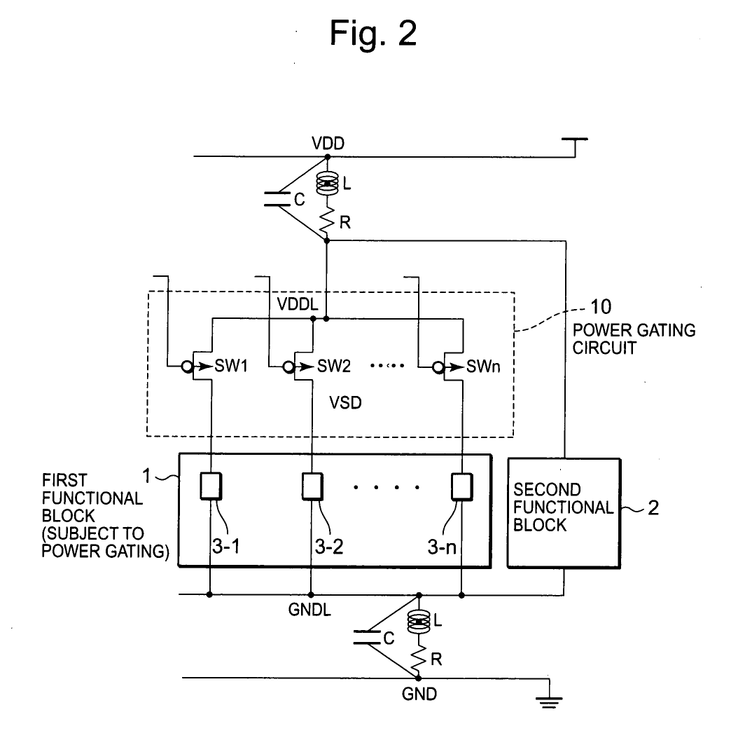

FIG. 2 schematically illustrates another exemplary semiconductor integrated circuit to be designed. In FIG. 2, elements which are similar to those in FIG. 1 bear the same reference numerals, and description thereof is omitted. In FIG. 2, the first functional block 1 includes a plurality of functional blocks 3-1-3-n. One of the plurality of power supply switches SW1-SWn is provided to each of the plurality of functional blocks 3-1-3-n. Alternatively, one functional block 3 (not shown) may be provided with a plurality of power supply switches.

As illustrated in FIGS. 1 and 2, the power gating circuit 10 according to the present embodiment has the plurality of power supply switches SW1-SWn provided in parallel. In the standby mode, all the power supply switches SW1-SWn are off, and power supply to the first functional block 1 is interrupted. As a result, leakage current in the first functional block 1 is greatly decreased, and the power consumption in the standby mode is lowered.

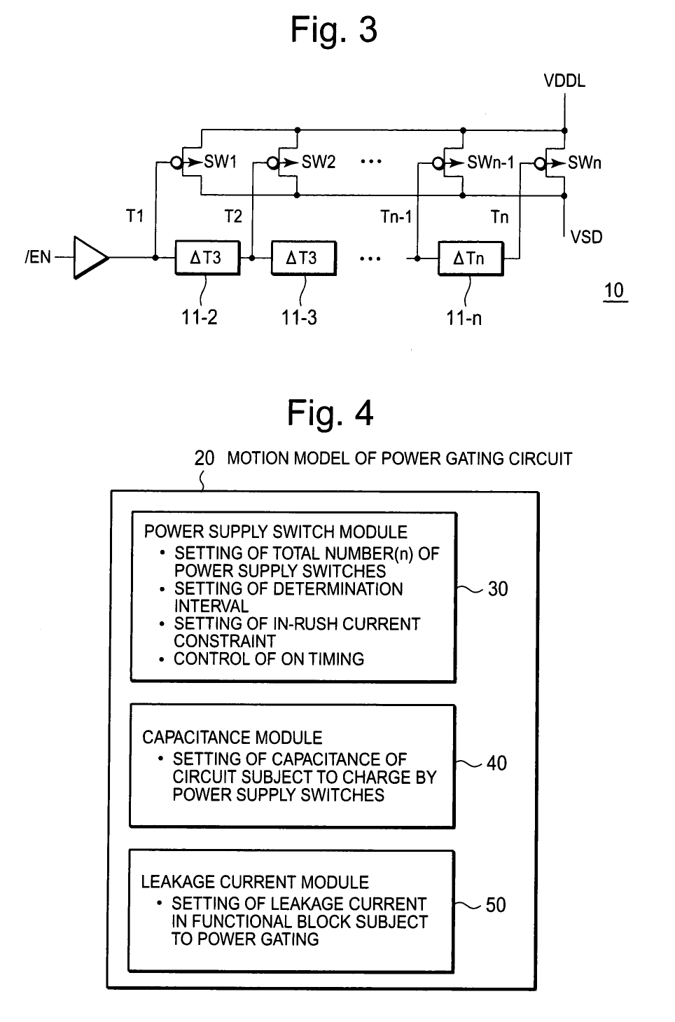

When power supply to the first functional block 1 is resumed, the power supply switches SW1-SWn are turned on. Here, in-rush current flows through the power gating circuit 10. When the in-rush current or the temporal differential value thereof is large, power supply noise caused by self-induced voltage of a common inductance also becomes large. The power supply noise is propagated to the second functional block 2 connected to the common power supply (VDDL) and may make the second functional block 2 malfunction. Therefore, it is necessary to lower a peak value or variation per unit time of the in-rush current. In order to lower the peak value or the variation per unit time of the in-rush current, the power supply switches SW1-SWn of the power gating circuit 10 are turned on not simultaneously but one by one. An exemplary structure to attain this is illustrated in FIG. 3.

The power gating circuit 10 illustrated in FIG. 3 not only has the plurality of power supply switches SW1-SWn but also has a delay circuit group formed of a plurality of delay circuits 11-2-11-n. The plurality of delay circuits 11-2-11-n are connected in series, and outputs thereof are connected to the power supply switches SW2-SWn, respectively. By the delay circuit group, an activation signal/EN is supplied to the respective power supply switches SW1-SWn at different timings. The activation signal/EN is a signal to turn on the power supply switches SW1-SWn. When the level of the activation signal/EN changes from H to L, the power supply switches (p-channel transistors) are turned on.

When the power supply switch SW1 is turned on at time T1, the power supply switch SW2 is turned on at time T2 which is subsequent to the time T1 (T2=T1+ΔT2). Similarly, after a predetermined delay time, the subsequent power supply switch is turned on. In this way, the plurality of power supply switches SW1-SWn are turned on one by one at different timings (T1, T2, . . . Tn−1, and Tn). The time interval between two temporally adjacent timings at which the plurality of power supply switches SW1-SWn are turned on is defined by respective delay times (ΔT2−ΔTn) of the delay circuits 11-2-11-n.

In the power gating circuit 10 illustrated in FIG. 3, when the delay times (ΔT2−ΔTn) are too short, the time periods during which the in-rush current is caused overlap. This increases the peak value and the variation per unit time of the in-rush current, which is a cause of a malfunction of the circuit due to power supply noise. On the other hand, when the delay times (ΔT2-ΔTn) are too long, time until the first functional block 1 becomes operable becomes long, which lowers the operation speed of the semiconductor integrated circuit having therein the power gating circuit 10.

Therefore, according to the present invention, optimum values for the delay times ΔT2-ΔTn are determined. In other words, timings at which the plurality of power supply switches SW1-SWn are turned on are optimized. In particular, best timings at which the power supply switches SW1-SWn are turned on are determined such that a desired constraint on the in-rush current is satisfied. Here, the constraint on the in-rush current means the maximum value (admissible value) of the in-rush current or the maximum value (admissible value) of the temporal differential value of the in-rush current, and hereinafter referred to as an “in-rush current constraint”. As described in detail in the following, according to the present invention, before the power gating circuit 10 is designed, the best timings at which the power supply switches SW1-SWn are turned on are determined through a circuit simulation such that the in-rush current constraint is satisfied. In the circuit simulation, a motion model of the power gating circuit 10 which is described in the following is used.
2. Motion Model of Power Gating Circuit

In the present embodiment, a “motion model” where operation and voltage-current characteristics of the power gating circuit 10 are modeled is used. The motion model is described in Hardware Description Language (HDL). By performing the motion model using a circuit simulator, operation of the power gating circuit 10 can be simulated. As described in the following, the motion model according to the present embodiment automatically controls the timings at which the plurality of power supply switches SW1-SWn are turned on such that the desired in-rush current constraint is satisfied.

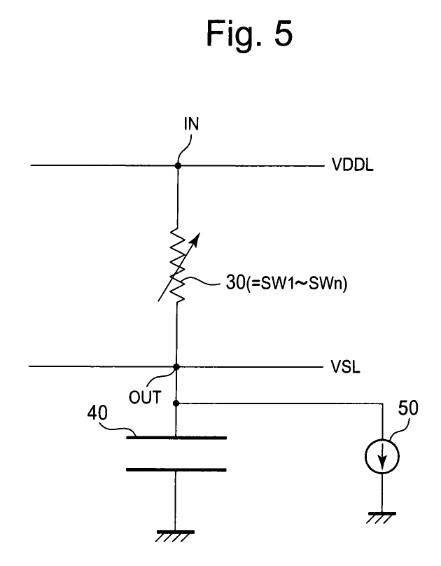

FIG. 4 schematically illustrates functions of a motion model 20 according to the present embodiment. FIG. 5 conceptually illustrates the motion model 20 according to the present embodiment. The motion model 20 according to the present embodiment has a power supply switch module 30, a capacitance module 40, and a leakage current module 50.
2-1. Power Supply Switch Module

The power supply switch module 30 is a module with regard to the power supply switches SW1-SWn in the power gating circuit 10.

First, the power supply switch module 30 provides a structure and characteristics of the power supply switches SW1-SWn. In order to attain this, the total number (n) of the power supply switches used in the power gating circuit 10 is set in the power supply switch module 30. Here, a case is assumed where n power supply switches SW1-SWn are connected in parallel between an input terminal IN and an output terminal OUT. In this case, as illustrated in FIG. 5, the power supply switches SW1-SWn may be modeled as a “variable resistance” connected between the input terminal IN and the output terminal OUT. The resistance value of the variable resistance changes according to the number i (i=0−n) of power supply switches which are on, and decreases as the number i of power supply switches which are on increases. By modeling the power supply switches SW1-SWn as a simple variable resistance, time necessary for the circuit simulation to be described in the following can be made shorter.

Second, the power supply switch module 30 provides a function to optimize the timings at which the power supply switches SW1-SWn are turned on. In particular, the power supply switch module 30 provides a function to automatically control the timings at which the power supply switches SW1-SWn are turned on such that the desired in-rush current constraint is satisfied. In order to attain this, the in-rush current constraint is set in the power supply switch module 30. The in-rush current constraint may be set at an arbitrary value according to a request by a user. Exemplary in-rush current constraints include the maximum value (admissible value) of the in-rush current and the maximum value (admissible value) of the temporal differential value of the in-rush current.

The in-rush current and the temporal differential value thereof become larger as the time interval (ΔT) between two temporally adjacent timings at which the plurality of power supply switches SW1-SWn are turned on becomes shorter, and as the number of power supply switches which are simultaneously turned on becomes larger. An exemplary technique to determine the timings at which the plurality of power supply switches SW1-SWn are turned on such that the in-rush current constraint is satisfied is as follows.

(a) First, the in-rush current or the variation per unit time thereof when the number (i) of power supply switches which are on increases by a predetermined number (1 or an arbitrary number) is estimated at predetermined intervals.

(b) Then, determination is made whether the estimated value satisfies the in-rush current constraint or not.

(c) The predetermined number of power supply switches are turned on only when the in-rush current constraint is satisfied.

(d) The above (a)-(c) are repeatedly carried out until the number i of power supply switches which are on reaches the total number n.

The function to carry out the processing described in the above is included in the power supply switch module 30. In order to attain this, the predetermined intervals (hereinafter referred to as “determination intervals”) are set in the power supply switch module 30.

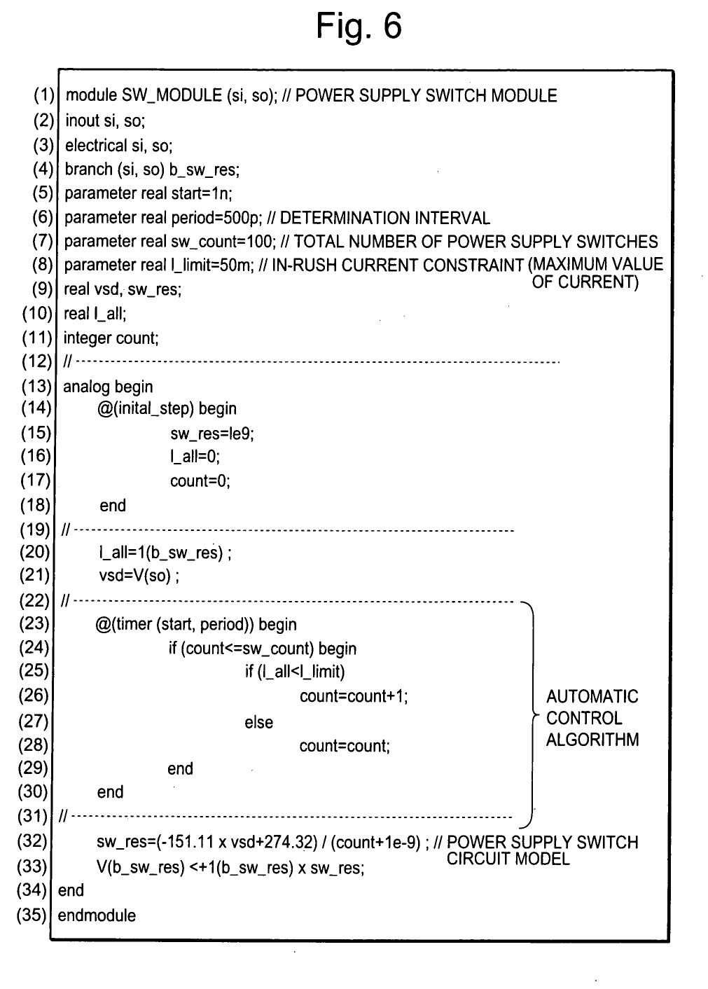

FIG. 6 illustrates an exemplary power supply switch module 30. The power supply switch module 30 is described in Verilog-A which is an analog design language. Meaning of main descriptions in FIG. 6 is described in the following with reference to the line numbers.

(1) Module definition: the design name of the power supply switch module 30 (SW_MODULE) and the input/output ports (si and so) are defined. The ports, si and so, are exemplary corresponding to IN and OUT of FIG. 5.

(2) Port declaration (inout: bidirectional).

(3) Discipline declaration: characteristics of a signal connected to the input/output ports are defined (electrical: characteristics of potential and current).

(4) Branch declaration: a current path (b_sw_res) exists between the ports si and so.

(6) Setting of determination intervals (period).

(7) Setting of the total number n of the power supply switches (sw_count).

(8) Setting of the in-rush current constraint (I_limit). Here, as an example, the maximum value of the in-rush current is set as the in-rush current constraint.

(9) Variable declaration of voltage difference between si and so (vsd) and resistance value of the variable resistance between si and so (sw_res).

(10) Variable declaration of current (I_all) flowing through the power supply switches.

(11) Variable declaration of the number i of the power supply switches which are on (count).

(13) Start of description of analog operation.

(14)-(18) Initial setting: the number of the power supply switches which are on (count) is initially set to be zero.

(23)-(30) Loop processing: the above processings (a)-(c) are performed with regard to the respective determination intervals (period).

(24) The processing is performed until the number of the power supply switches which are on (count) reaches the total number of switches (sw_count).

(25)-(28) Determination processing: the number of the power supply switches which are on (count) is incremented by one when the current (I_all) satisfies the in-rush current constraint (I_limit), while the number of the power supply switches which are on (count) remains unchanged when the current (I_all) does not satisfy the in-rush current constraint (I_limit).

(32) Model of the power supply switches SW1-SWn: the power supply switches SW1-SWn are modeled as the variable resistance (sw_res) based on ON resistance characteristics. The variable resistance (sw_res) decreases as the number of the power supply switches which are on (count) increases.

(33) Relational expression of V=IR: the relationship among the voltage between si and so (V(b_sw_res)), the current (I_all=I(b_sw_res)), and the variable resistance (SW_res) is expressed, and the in-rush current is estimated.

In this way, the in-rush current (I_all) and the in-rush current constraint (I_limit) are compared with each other at the predetermined determination intervals (period). The variable (count) is incremented only when the in-rush current constraint (I_limit) is satisfied. This means that a power supply switch is newly turned on. The processing is repeated until the variable (count) reaches the total number of the power supply switches (sw_count). This means that the power supply switches SW1-SWn are turned on one by one such that the in-rush current constraint (I_limit) is satisfied. The transition timings of the variable (count) correspond to the timings at which the power supply switches SW1-SWn are turned on. In order to determine with accuracy the timings at which the power supply switches SW1-SWn are turned on, it is preferable that the determination intervals (period) be set to be small to some extent.
2-2. Capacitance Module

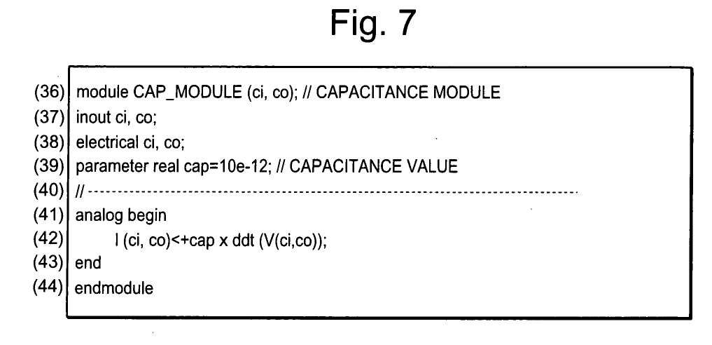

The capacitance module 40 is a module for setting capacitance of a circuit subject to charge/discharge by the power supply switches SW1-SWn (see FIG. 5). In the circuit simulation to be described later, the capacitance set by the capacitance module 40 is also taken into consideration. FIG. 7 illustrates an exemplary capacitance module 40. The capacitance module 40 is described in Verilog-A which is an analog design Language. Meaning of main descriptions in FIG. 7 is described in the following with reference to the line numbers.

(36) Module definition: the design name of the capacitance module 40 (CAP MODULE) and the input/output ports (ci and co) are defined.

(39) Setting of the capacitance (cap).

(41)-(43) Description of analog operation.
2-3. Leakage Current Module

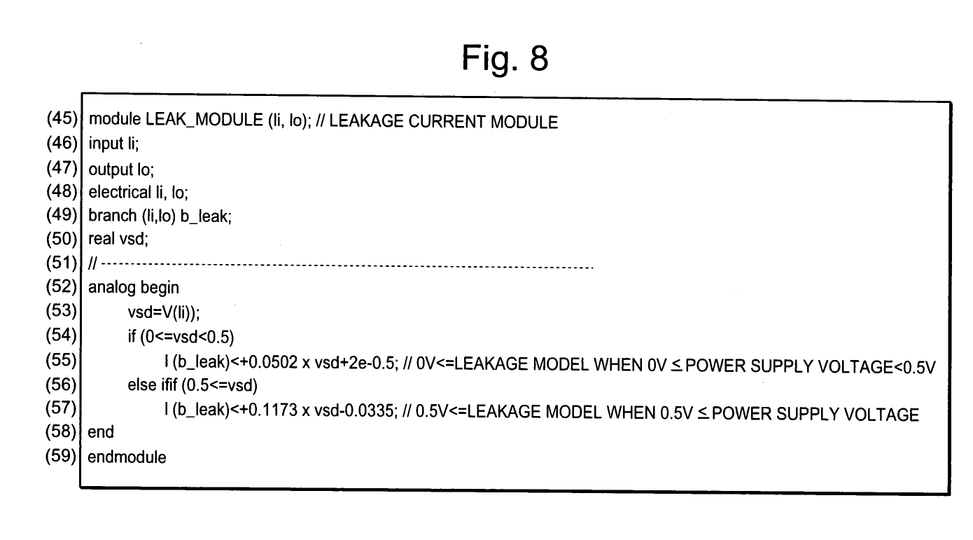

The leakage current module 50 is a module for setting leakage current in the first functional block 1 subject to the power gating (see FIG. 5). In the circuit simulation to be described later, the leakage current set by the leakage current module 50 is also taken into consideration. FIG. 8 illustrates an exemplary leakage current module 50. The leakage current module 50 is described in Verilog-A which is an analog design language. Meaning of main descriptions in FIG. 8 is described in the following with reference to the line numbers.

(45) Module definition: the design name of the leakage current module 50 (LEAK_MODULE) and the input/output ports (li and lo) are defined.

(49) Branch declaration: a leakage current path (b_leak) exists between the ports li and lo.

(50) Variable declaration of the voltage (vsd).

(52)-(58): Description of analog operation.

(53) The voltage (vsd) is input voltage (V(li)). As illustrated in FIG. 5, the input voltage (V(li)) is output voltage of the power supply switch module 30, that is, voltage supplied through the power gating circuit 10 to the first functional block 1.

(54)-(57) Setting of the leakage current: the leakage current (I(b_leak)) changes according to the input voltage (vsd). Further, in the present embodiment, different formulae for determining the leakage current (I(b_leak)) are used when the input voltage (vsd) is lower than 0.5 V and when the input voltage (vsd) is equal to or higher than 0.5 V.
3. Circuit Simulation

As described in the above, the motion model 20 of the power gating circuit 10 is provided. For example, the motion model 20 is described in Verilog-A and has the plurality of modules (see FIGS. 6 to 8). The circuit simulation is performed using the motion model 20. More specifically, a model circuit the functions and operation of which are defined by the motion model 20 is made to operate in a computer. The circuit simulation is performed using a predetermined analog simulator.

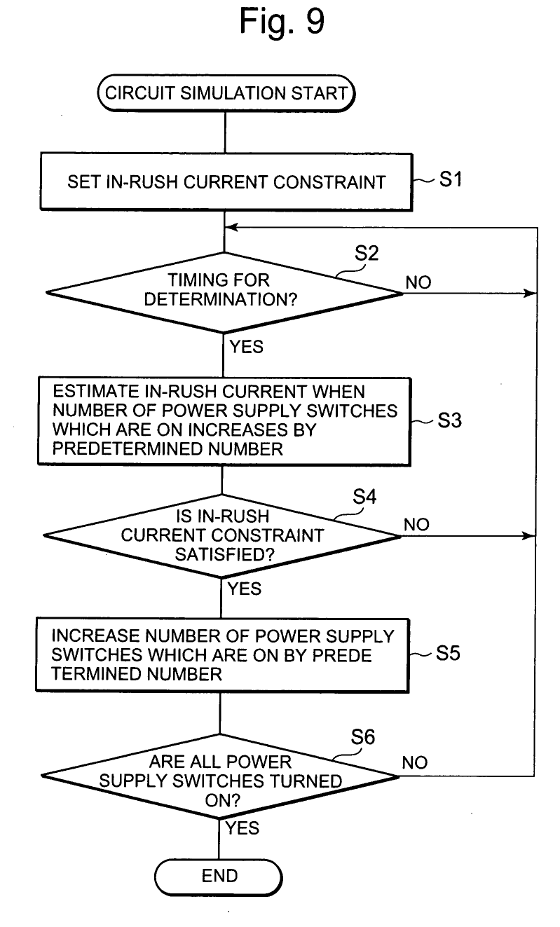

FIG. 9 is a flow chart illustrating operation of the motion model in the circuit simulation. First, the in-rush current constraint is set (Step S1). After that, as time passes, timings for determination come at set determination intervals (Step S2). At a timing for determination, the in-rush current (or the variation thereof) when the number i of the power supply switches which are on increases by a predetermined number (1 or an arbitrary number) is estimated (Step S3). Then, it is determined whether the estimated in-rush current (or the variation thereof) satisfies the in-rush current constraint or not (Step S4). When the in-rush current constraint is not satisfied (No in Step S4), the number i does not increase and the processing goes back to Step S2. On the other hand, when the in-rush current constraint is satisfied (Yes in Step S4), the number i increases by the predetermined number (Step S5). When a power supply switch which is not on exists (No in Step S6), the processing goes back to Step S2. Steps S2-S5 are repeated until the number i reaches the total number n of the power supply switches. When all the power supply switches SW1-SWn are turned on (Yes in Step S6), the circuit simulation ends.

It is to be noted that, when the power supply switches SW1-SWn are modeled as the variable resistance, the circuit simulator can regard the plurality of power supply switches SW1-SWn as one variable resistance. In this case, the efficiency of the circuit simulation is improved, which is preferable.

As described in the above, in the circuit simulation, the power supply switches SW1-SWn are turned on one by one such that the desired in-rush current constraint is satisfied. More specifically, the timings at which the power supply switches SW1-SWn are turned on are automatically controlled and determined such that the in-rush current constraint is satisfied. Based on the result of the circuit simulation, “power supply switch ON timing data” which indicates the timings at which the power supply switches SW1-SWn are turned on is generated. For example, the transition times of the above-described variable (count) indicating the number i of the power supply switches which are on correspond to the timings at which the power supply switches SW1-SWn are turned on. Accordingly, by referring to the data which indicates the state transition of the variable (count), the power supply switch ON timing data can be generated. The state transition of the variable (count) may be displayed on the screen of a workstation. Alternatively, a module for automatically outputting the timings at which the power supply switches are turned on may be incorporated in the motion model 20.
4. Design of Power Gating Circuit

As described in the above, the timings at which the power supply switches SW1-SWn are turned on are determined such that the in-rush current constraint is satisfied. In other words, by turning on the plurality of power supply switches SW1-SWn one by one at the timings, the in-rush current constraint is satisfied. Accordingly, the power gating circuit 10 may be actually designed referring to the generated power supply switch ON timing, data. By this, the power gating circuit 10 which satisfies the desired in-rush current constraint is automatically obtained.

The power gating circuit 10 has, for example, the structure illustrated in FIG. 3. In this case, the delay times (ΔT2−ΔTn) of the delay circuits 11-2-11-n are determined based on the timings at which the power supply switches SW1-SWn are turned on, respectively. More specifically, time intervals (time differences) between timings at which the power supply switches SW1-SWn are turned on are calculated from the power supply switch ON timing data. The respective delay times (ΔT2-ΔTn) are determined so as to conform to the calculated time intervals. The design of the power gating circuit 10 is performed using, for example, ordinary logic synthesis.

It is to be noted that, in the present embodiment, the delay times (ΔT2-ΔTn) are determined not only so as to satisfy the in-rush current constraint but also so as not to be too long. This is because, in the circuit simulation, the determination is made at the predetermined determination intervals and the power supply switches are turned on immediately after the in-rush current constraint is satisfied. In other words, the motion model 20 gradually increases the time interval (time difference) between two temporally adjacent timings at which the power supply switches SW1-SWn are turned on by a value corresponding to the determination interval, and immediately after the in-rush current constraint is satisfied, the time interval is fixed. Therefore, the time intervals between two temporally adjacent timings at which the power supply switches SW1-SWn are turned on, that is, the delay times, are prevented from becoming meaninglessly long. As a result, time until operation of the first functional block 1 is resumed is prevented from becoming too long, and thus, the operation speed of the semiconductor integrated circuit having therein the power gating circuit 10 is prevented from being decreased. In order to determine the delay times with accuracy, it is preferable that the determination intervals be set to be small to some extent.
5. Design System of Semiconductor Integrated Circuit

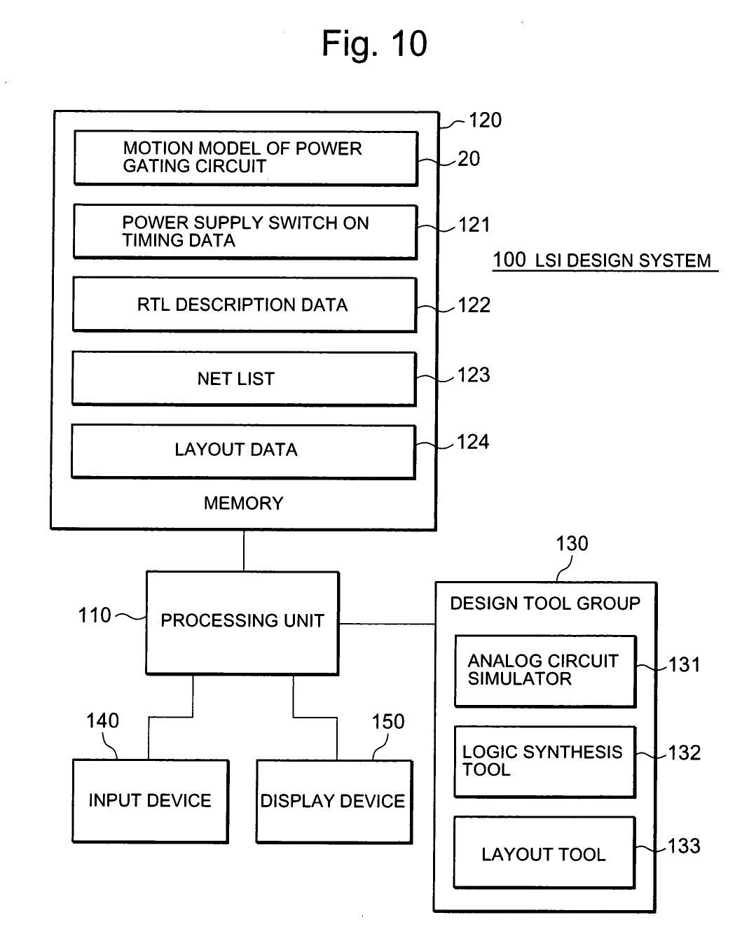

The semiconductor integrated circuit having therein the power gating circuit 10 according to the present embodiment is designed using a computer. The computer system for the designing may be appropriately organized by those skilled in the art. FIG. 10 illustrates an exemplary computer system (LSI design system).

An LSI design system 100 includes a processing unit 110, a memory 120, a design tool group 130, an input device 140, and a display device 150. The memory 120 stores the above-described motion model 20, power supply switch ON timing data 121, RTL description data 122, a net list 123, a layout data 124, and the like. The memory 120 is, for example, a RAM or an HDD. The design tool group 130 includes an analog circuit simulator 131, a logic synthesis tool 132, a layout tool 133, and the like. These are software products executed by the processing unit 110. The input device 140 is, for example, a keyboard or a mouse. A designer can input data or a command using the input device 140 referring to information displayed on the display device 150.

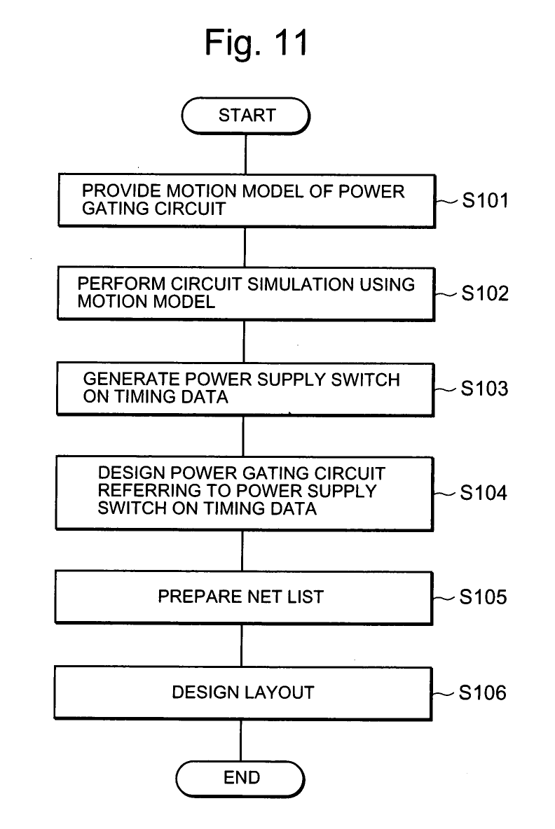

FIG. 11 is a flowchart schematically illustrating a design method of the semiconductor integrated circuit according to the present embodiment. First, the motion model 20 of the power gating circuit 10 is provided (Step S101). The motion model 20 is described in, for example, Verilog-A (see FIGS. 6 to 8), and stored in the memory 120.

Then, the processing unit 110 executes the analog circuit simulator 131 and performs the circuit simulation using the motion model 20 (Step S102). More specifically, according to a command from the analog circuit simulator 131, the processing unit 110 reads the motion model 20 from the memory 120 and performs the circuit simulation of the motion model 20. Details of the processing in the circuit simulation are as illustrated in FIG. 9. As a result, the timings at which the power supply switches SW1-SWn are turned on are optimized such that the in-rush current constraint is satisfied. Based on the result of the circuit simulation, the processing unit 110 generates the power supply switch ON timing data 121 which indicates the determined timings at which the power supply switches SW1-SWn are turned on (Step S103). The power supply switch ON timing data 121 is stored in the memory 120.

Then, the semiconductor integrated circuit is designed. For example, the RTL description data 122 which indicates the RTL description of the semiconductor integrated circuit is prepared and stored in the memory 120. Logic design of the power gating circuit 10 is performed referring to the power supply switch ON timing data 121 (Step S104). More specifically, the timings at which the power supply switches SW1-SWn are turned on indicated by the power supply switch ON timing data 121 are reflected on the delay times (ΔT2-ΔTn) of the delay circuits 11-2-11-n.

Then, the processing unit 110 executes the logic synthesis tool 132 and performs logic synthesis processing with regard to the RTL description indicated by the RTL description data 122. As a result, the net list 123 which indicates the connection relationship among elements in the semiconductor integrated circuit is prepared (Step S105). Then, the processing unit 110 executes the layout tool 133 and performs layout design based on the net list 123 (Step S106). As a result, the layout data 124 which indicates the layout of the semiconductor integrated circuit to be designed is prepared.
6. Effect

According to the present invention, before the power gating circuit 10 is designed, the best timings at which the power supply switches SW1-SWn are turned on are determined through the circuit simulation using the motion model 20. The timings are determined such that the desired in-rush current constraint is satisfied. Therefore, in the power gating circuit 10 designed referring to the timings, the desired in-rush current constraint is automatically satisfied. As a result, a malfunction of the circuit due to power supply noise is prevented.

Here, a case is reviewed where, after the power gating circuit 10 is designed, the simulation of the in-rush current is performed using the design data thereof. In this case, if the in-rush current constraint is not satisfied, it is necessary to amend the design of the power gating circuit 10, which increases the design time. On the other hand, according to the present invention, it is not necessary to repeat the simulation of the in-rush current. This is because the motion model 20 is structured such that the timings at which the power supply switches SW1-SWn are turned on are automatically controlled. By performing the circuit simulation using the motion model 20 only once, the timings which satisfy the in-rush current constraint are determined. Therefore, time necessary for designing the semiconductor integrated circuit is made shorter.

Further, in the motion model 20, the power supply switches SW1-SWn are modeled not as a detailed net list specifying the respective transistors but as a simple variable resistance. More specifically, the circuit simulator can treat the plurality of power supply switches SW1-SWn as one variable resistance. Therefore, the efficiency of the above-described one circuit simulation is improved and time necessary for the simulation is effectively decreased.

Further, the motion model 20 gradually increases the time interval between two temporally adjacent timings at which the power supply switches SW1-SWn are turned on, and immediately after the in-rush current constraint is satisfied, the time interval is fixed. Therefore, the time intervals between two temporally adjacent timings at which the power supply switches SW1-SWn are turned on are prevented from becoming meaninglessly too long. More specifically, the time intervals between the timings are determined not only so as to satisfy the in-rush current constraint but also so as not to be too long. As a result, time until operation of the first functional block 1 is resumed is prevented from becoming too long, and thus, the operation speed of the semiconductor integrated circuit having therein the power gating circuit 10 is prevented from being decreased.

Although the present invention is described with reference to the above-described embodiment, it is apparent that the present invention is not limited to the above embodiments, but may be modified and changed without departing from the scope and spirit of the invention.

What is claimed is:

1. A design method of a semiconductor integrated circuit, the semiconductor integrated circuit having therein a power gating circuit being provided between a functional block and a power supply, and having a plurality of power supply switches connected to in parallel each other, the method comprising:
(A) providing a motion model of the power gating circuit;
(B) setting a constraint on in-rush current;
(C) performing a circuit simulation using the motion model; and
(D) generating timing data indicative of a plurality of timings at which the plurality of power supply switches are turned on respectively, in response to a result of the circuit simulation,
wherein (C) performing the circuit simulation includes turning on the plurality of power supply switches step by step such that the constraint is satisfied.

2. The design method of claim 1, wherein (C) performing the circuit simulation includes gradually increasing the time interval between two temporally adjacent timings at which the plurality of power supply switches are turned on from a predetermined value, and fixing, immediately after the constraint is satisfied, the time interval between two temporally adjacent timings at which the plurality of power supply switches are turned on.

3. The design method of claim 1, wherein:
the motion model comprises a power supply switch module; and
when the number of power supply switches which are on among the plurality of power supply switches is denoted as i,
the plurality of power supply switches are given as a variable resistance the resistance value of which decreases as the number i increases.

4. The design method of claim 3, wherein (C) performing the circuit simulation comprises:
(c1) estimating at predetermined intervals the in-rush current or the variation per unit time thereof when the number i increases by a predetermined number;
(c2) judging whether the estimated in-rush current or variation satisfies the constraint or not;
(c3) making the number i remain unchanged when the constraint is not satisfied and to increase the number i by the predetermined number when the constraint is satisfied; and
(c4) repeating the functions (c1) to (c3) until the number i reaches the total number of the plurality of power supply switches.

5. The design method of claim 3, wherein (D) generating timing data includes generating the timing data based on increment timing of the number i.

6. The design method of claim 3, wherein the motion model further comprises a capacitance module for simulating capacitance of a circuit subject to charge/discharge by the plurality of power supply switches.

7. The design method of claim 3, wherein the motion model further comprises a leakage current module for simulating leakage current in the functional block.

8. The design method of claim 7, wherein the leakage current is set so as to change according to voltage supplied through the power gating circuit to the functional block.

9. The design method of claim 1, further comprising (E) designing the power gating circuit based on the timings at which the plurality of power supply switches are turned on indicated by the timing data.

10. The design method of claim 9, wherein:
the power gating circuit further has a delay circuit group for supplying an activation signal to the respective plurality of power supply switches with different delay times, the activation signal being for turning on the plurality of power supply switches; and
(E) designing the power gating circuit includes determining the different delay times based on the timings at which the plurality of power supply switches are turned on.

11. A design system of a semiconductor integrated circuit, wherein:
the semiconductor integrated circuit has therein a power gating circuit being provided between a functional block and a power supply, and having a plurality of power supply switches connected to in parallel each other;
the design system comprises:
a memory for storing a motion model of the power gating circuit; and
a processing unit for reading the motion model from the memory and for performing a circuit simulation of the motion model;
in the motion model, a constraint on in-rush current is set;
in the circuit simulation, the motion model turns on the plurality of power supply switches one by one so that the constraint is satisfied; and
the processing unit generates timing data indicating the timings at which the plurality of power supply switches are turned on based on the result of the circuit simulation.

12. The design system of claim 11, wherein, in the circuit simulation, the motion model gradually increases the time interval between two temporally adjacent timings at which the plurality of power supply switches are turned on from a predetermined value, and, immediately after the constraint is satisfied, the time interval between two temporally adjacent timings at which the plurality of power supply switches are turned on is fixed.

13. The design system of claim 11, wherein:
the motion model has a power supply switch module; and
the power supply switch module comprises, when the number of power supply switches which are on among the plurality of power supply switches is denoted as i, the functions of:
(a) setting the constraint on the in-rush current;
(b) estimating at predetermined intervals the in-rush current or the variation per unit time thereof when the number i increases by a predetermined number;
(c) judging whether the estimated in-rush current or variation satisfies the constraint or not;
(d) making the number i remain unchanged when the constraint is not satisfied and to increase the number i by the predetermined number when the constraint is satisfied; and
(e) repeating the functions (b) to (d) until the number i reaches the total number of the plurality of power supply switches.

14. The design system of claim 13, wherein, in the motion model, the plurality of power supply switches are given as a variable resistance the resistance value of which decreases as the number i increases.

15. The design system of claim 11, wherein the processing unit further designs the power gating circuit based on the timings at which the plurality of power supply switches are turned on indicated by the timing data.
